(19) United States
(12) Patent Application Publication
(10) Pub. No.: US 2024/0269687 A1
(43) Pub. Date: Aug. 15, 2024

(54) METHOD AND SYSTEM FOR WASTE SEPARATION USING A MULTI-SPIRAL SEPARATOR

(71) Applicant: Thomas A Valerio, Atlanta, GA (US)

(72) Inventor: Thomas A Valerio, Atlanta, GA (US)

(21) Appl. No.: 18/642,028

(22) Filed: Apr. 22, 2024

Related U.S. Application Data
(63) Continuation of application No. PCT/US22/47617, filed on Oct. 24, 2022.
(60) Provisional application No. 63/270,963, filed on Oct. 22, 2021.

(51) Int. Cl. B03B 5/52; B03B 9/06

(52) U.S. Cl. CPC B03B 5/52; B03B 9/06

(57) ABSTRACT

A multi-spiral separator for separating waste material has a first separator, a second clearing separator, and a trough. The first separator and the second clearing separator reside in the trough and the second clearing separator acts to prevent or reduce material from jamming the separator.

### RELATED APPLICATIONS

This application is a continuation of International Patent Application No. PCT/US2022/47617, filed on Oct. 24, 2022, which claims the benefit of U.S. Provisional Patent Application No. 63/270,963, filed Oct. 22, 2021, each of which is incorporated herein by reference in its entirety.

### TECHNICAL FIELD

This application relates to material separation, and this application relates systems and methods for recovering metals from recycled materials.

### BACKGROUND

Recycling of waste materials is highly desirable from many viewpoints, not the least of which are financial and ecological. Properly sorted recyclable materials can often be sold for significant revenue. Many of the more valuable recyclable materials do not biodegrade within a short period, and so their recycling significantly reduces the strain on local landfills and ultimately the environment.

Disposal of solid waste material creates a problem. Disposal of scrap or junk vehicles are of particular concern since millions of passenger cars, trucks and busses continuously become old or non-usable. Typically, waste streams are composed of a variety of types of waste materials. One such waste stream is generated from the recovery and recycling of automobiles or other large machinery and appliances. For examples, at the end of its useful life, an automobile is shredded. This shredded material is processed to recover ferrous and non-ferrous metals. The remaining materials, referred to as automobile shredder residue (ASR), which may still include ferrous and non-ferrous metals, including copper wire and other recyclable materials, is typically disposed of in a landfill.

Efforts have been made to further recover materials, such as non-ferrous metals including copper from copper wiring and plastics. Similar efforts have been made to recover materials from whitegood shredder residue (WSR), which are the waste materials left over after recovering ferrous metals from shredded machinery or large appliances. Other waste streams that have recoverable materials may include electronic components (also known as “e-waste” or “waste electrical and electronic equipment (WEEE)), building components, retrieved landfill material, or other industrial waste streams. These recoverable materials are generally of value only when they have been separated into like-type materials. However, in many instances, no cost-effective methods are available to effectively sort waste materials that contain diverse materials.

Accordingly, there is always a need for improved methods and systems for separating a waste stream.

### SUMMARY

This application discloses a method of sorting and separating waste material that includes providing the waste material (having waste particles); using a multi-spiral separator that has two separators in an elongated trough, a first separator with grooves and first blades and a second clearing separator having second blades capable for clearing the elongated trough; introducing the waste material into the multi-spiral separator; and separating the waste material using the multi-spiral separator. The waste particles separate according to the particles' settling velocities or densities, a heavy fraction settles into the grooves and a light fraction remains at the top of the waste stream; and the heavy fraction travels up the multi-spiral separator to be collected and the light fraction is pushed to the back of the multi-spiral separator and exits a lower end of the trough. The trough may be at an angle between 0 and 30 degrees or 5 and 25 degrees to the horizontal.

Another aspect includes a multi-spiral separator for separating waste material having a first separator having upper end and a lower end; a second clearing separator; and a trough. The first separator and the second separator reside in the trough and the first separator can be smaller than the second separator. The second clearing separator can be a spiral screw or may extend from the upper end to less than the lower end of the trough. The second clearing separator can be on the side opposite to the groove or blade direction of the first separator. The first separator may be a ribbon screw.

Another aspect includes a system for separating waste material, having a sizer for sizing the material; a multi-spiral separator configured to separate the material into a heavy fraction and the light fraction in which the multi-spiral separator has two separators in an elongated trough. The first separator can have grooves and blades and a second clearing separator having second blades capable for clearing the elongated trough. The system can have a collector. The system can have nozzles that can deliver a stream of wash liquid the multi-spiral separator to push the light fraction in a direction opposite the heavy fraction.

### DESCRIPTION OF THE FIGURES

FIG. 1 is a perspective view of one embodiment of the present invention;

FIG. 2 is an exploded view of the embodiment shown in FIG. 1 showing the relationship between the first and second separators;

FIG. 3 is a top-perspective view of one embodiment of the present invention;

FIG. 4 is an exemplary flow diagram for recovering metals from a waste stream; and

FIG. 5 is another exemplary flow diagram for recovering metals from a waste stream.

### DETAILED DESCRIPTION

Detailed embodiments of the systems and methods are disclosed herein. However, it is to be understood that the disclosed embodiments are merely illustrative of the systems, devices, and methods, which may be embodied in various forms. Therefore, specific functional details disclosed herein are not to be interpreted as limiting but merely as a basis for the claims and as a representative basis for teaching one skilled in the art to variously employ the systems, devices, and methods disclosed herein.

The attached figures illustrate a gravity separation system in accordance with an embodiment of the present disclosure. This application discloses a gravity separation system having multiple spiral concentrators or a multi-spiral separator. The multiple spiral separators are used with wet or dry gravity separation of solids and two or more separators operating in a trough.

The methods and system can be used to treat waste material according to one or more illustrative embodiments. In one embodiment, the waste stream may include waste streams having characteristics similar to incinerator ash, ASR, WSR, and WEEE. ASR, WSR, and WEEE, and incinerator ash have metals as hair wires or electronic pin connectors or metal with flat, flake-like shapes. A “mixed waste stream containing metals” includes, but is not limited to, these waste streams. In another embodiment, the waste stream may include waste streams having characteristics similar to waste-to-energy slag, steelmaking slag, and ferrochrome slag. Further, the waste may include other incinerated waste, which may be from other mixed-waste incinerators or waste-to-energy facilities. The waste material can include segregated, or a mixed ash product that may include one or more of fly ash, flue dust, grate siftings, bag house solids, and pozzolanic ash solids in combination with the bottom ash.

Embodiments include methods and systems for the separation and recovery of metal from a waste material using a multi-screw separator. The disclosed embodiments are particularly well-suited for recovering metals from metal-containing waste material. Some embodiments of the disclosed methods include one or more of the following three steps: (1) sizing, (2) separating material using a multiple spiral separator, and (3) collecting the separated materials.

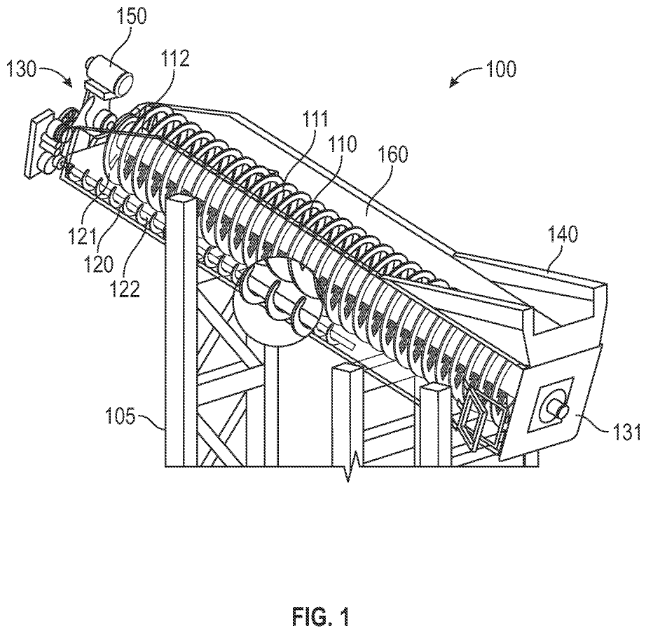

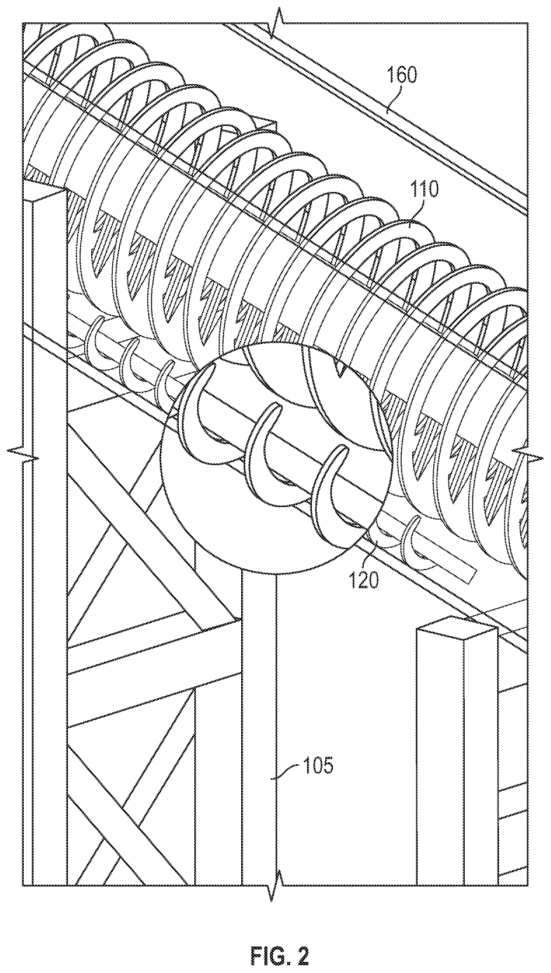

FIGS. 1 and 2 shows one embodiment of a multi-spiral separator 100. The multi-screw separator 100 has a frame 105 holding a first separator 110 and a second separator 120. The first separator 110 extends between an upper end 130 and a lower end 131; and the second clearing separator extends less than the lower end 131 and has blades or second blades 122 along shaft 121. The first separator 110 has blades 111 and a shaft 112. The lower end of the first separator 110 includes a partial tapering wall 140 defining an output 145. There is an elongated trough 160 between or including the upper end 103 and the lower end 131. The arrows in FIG. 2 show the direction of the waste stream as moved by the first and the second clearing separator in one embodiment.

The frame 105 can include an engine 150 for driving and providing power to the multi-spiral separator 100. The multi-spiral separator 100 and all associated motors and actuators can work hydraulically to enable the multi-spiral separator 100. The frame 105 supports the first separator 110.

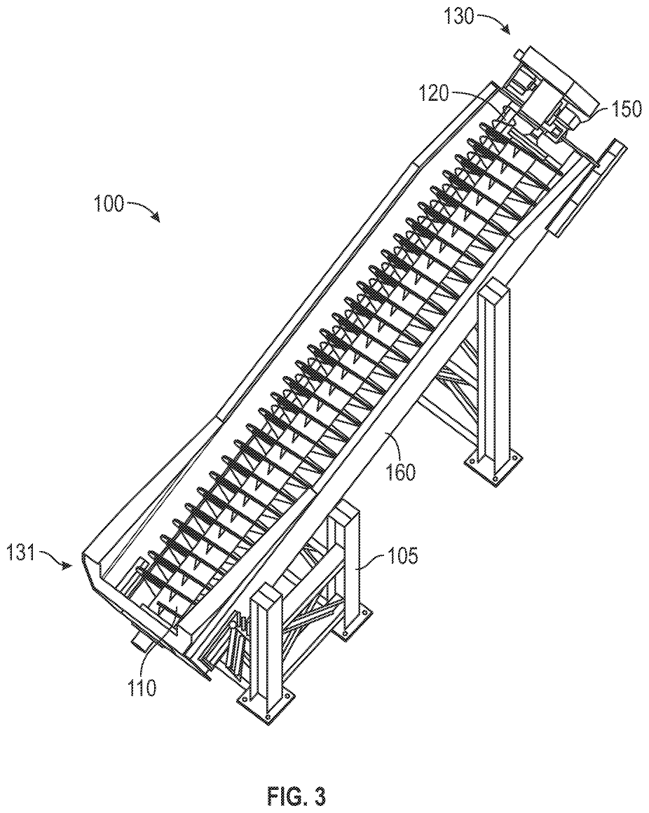

FIG. 3 shows a top-perspective view of the multi-spiral separator 100. The multi-spiral separator 100 has a first separator 110 and a second clearing separator 120. The first separator 110 is a right-handed screw and pushes material generally towards the right side of the trough 160 or to the opposite side where the second clearing separator 120 resides in the trough 160. Water may be added to the non-material side (side with a second clearing separator 120) and the second clearing separator turns to push material and water down the elongated trough 160 to help remove and prevent material from building up along the trough or trough raceway. The second clearing separator may push material toward the lower end 130. Material may be added towards the bottom or lower end of the tough to facilitate or faster separation. As can be seen, the water and lighter materials may overflow the rear weir.

As can be seen, one of the spiral separators can be larger than the other. The smaller spiral concentrator can flank the larger spiral concenter and push lighter material back into the top of the trough. In one arrangement, the blades of each spiral may be integrated, and the one or more spiral concentrators can run parallel. By adding the second spiral separator, the material is moved downward to clear the runway of the trough. In other embodiments, the blades of each spiral may not overlap. The second spiral separator or cleaner separator is on a side opposite the direction of the rotation of the first spiral separator.

In one embodiment, the rotation of the larger spiral concentrator/separator or ribbon screw is counter to that of the smaller concentrator or small screw. The second spiral separator moves to clear the pathway or elongated trough 160 between the upper end and lower ends. This reduces jamming of the multi-spiral separator.

The multi-spiral separator can be used for the wet gravity separation of solids according to their specific gravity, for example for separating various kinds of heavy material. In one example, the concentrate may be of higher specific gravity particles. Mids can include particles which may fall in specific gravity between those in the concentrates and those in the tailings or a mixture of high and low specific gravity particles which the apparatus has not succeeded in separating in concentrate or tailings. The tails are a solid fraction that are the bulk of the granular waste particles and some of the water. The water fraction includes water not required for handling granular tailings, some granular tailings, small, high specific gravity particles, which become trapped in the high velocity water stream but may be recovered by separate treatment of the water stream.

In one embodiment, vibrators may be attached to the trough to improve the separation.

In one embodiment, the materials can be processed by the multiple spiral concentrators. The materials undergoing gravity separation can be segregated into discrete size ranges based on, e.g., commercially available equipment and specifications. Exemplary and illustrative size ranges include about 2 to about 6 mm, about 6 to about 10 mm, about 10 mm to about 17 mm. about 17 mm to about 25 mm. about 25 mm to about 35 mm, and about 35 mm to about 100 mm. Materials about 100 mm and greater are removed from the system 100 through manual or automatic processing. An exemplary optimal size ratio upon segregation is about 3:1. Separation of the materials into discrete batch size ranges provides more effective processing at later processing stages of the system 100. More particularly, each fraction can be batched through system 100 to promote efficiency. In one embodiment, the ratio of the upper cut to lower cut may be less than 4. In another embodiment, the material can be narrowly size within ranges of, e.g., (0 to 0.5 mm) (0.5 mm to 2 mm) (2 mm to 6 mm) (6 mm to 10 mm) (10 mm to 25 mm) etc., or other sizes suitable to hindered settling separation.

FIGS. 1-3 show that the second clearing separator 120 can comprise a screw that can be referred to as an Archimedes screw. The screw type is mounted on a shaft extending between an upper end 130 and a lower end 131. The lower end of the shaft is received within the bearing in the for journaling the shaft. The upper end of the shaft is coupled to the motor mounted to the elongated trough 160 for rotating the shaft.

One of ordinary skill in the art also would understand that the separator described above may be one step in a multi-step process that concentrates and recovers recyclable materials, such as copper wire from ASR and WSR.

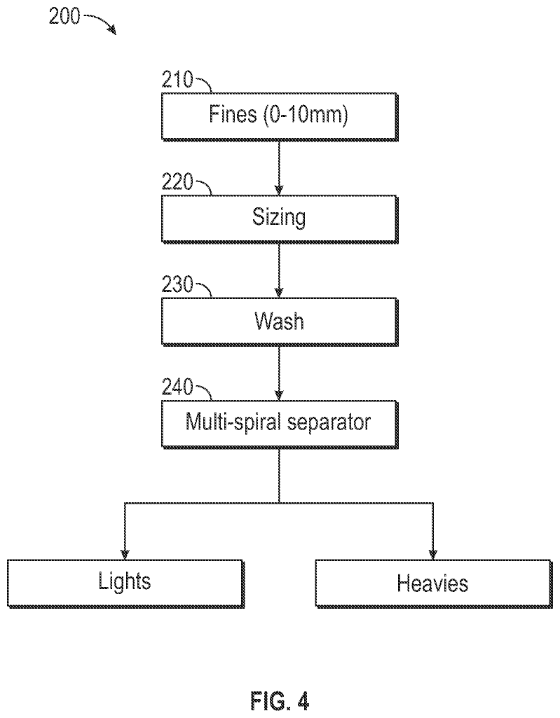

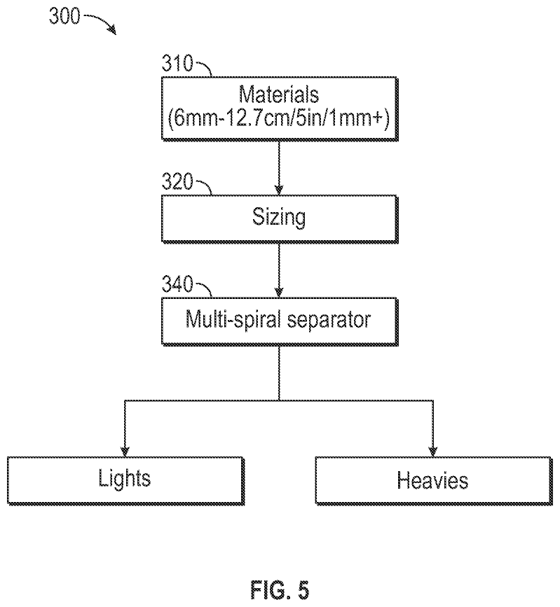

Referring to FIGS. 4 through 5, equipment layouts or flow diagrams for a mixed waste stream containing metals processing system are described. The equipment layout represents an exemplary layout and method. Therefore, various aspects may be omitted depending on implementation and design choice. In one embodiment illustrated in FIG. 4, the system 200 can include materials or fines from about 0 to 10 mm 210, which can be sized 220 and sorted, a round thickener 230 and an eccentric pump, and at least one multi-spiral separator/screen 240. In another embodiment illustrated in FIG. 5, the system 300 can include materials greater than about 1 mm to about 12.7 mm/5 inches 310, which may be sized 320, include a round thickener (not shown), and at least one multi-spiral separator/screen 340. In other embodiments, the materials can be sized to material greater than about 1 mm or greater than 10 mm or greater than 20 mm, which can be sized and sorted, include a round thickener, and include at least one multi-spiral separator/screen. The process and system can include a rougher, cleaner, and/or finisher multi-spiral separator. Additionally, and/or alternatively, the system can include a water table or other finishing and cleaning steps or separators. In each of the embodiments, the lights and heavies from the multi-spiral separator 100, can be collected and/or further processed by, e.g., a scavenger circuit.

In another embodiment, there can be three or more spiral separators. In this embodiment, the spiral clearing separator may be down the center of the trough or in the corners of the trough for clearing the center and corners. The two spiral separators may have different pitches and/or heights and one may be used, in order to separate different grades of material/metals.

In operation and use, specific embodiments include the use of a multi-spiral separator 100, which has two types of spiral concentrator. An example of a multi-spiral separator is shown in FIG. 1. During operation, the length and width of a series of grooves or blades create a classifying effect as the materials pass therethrough. The heavier concentrates settle into the bottom of the grooves upwards/against the introduced material is at the upper portion, and one or more spray heads or nozzles may continuously push the lighter material along the trough. The heavy concentrate continues moving forward, falling out of the grooves and into a container. In one embodiment, the chamber is a continuous solid structure. The spray heads or nozzles can be disposed along a wash water supply. The second clearing separator or the cleaner screw can keep the path or raceway clear on the side opposite the direction of the rotation of the first separator.

The multi-spiral separators are suitable for use as roughers or cleaners, depending on their size. In one embodiment, the sizes range from small 1 foot diameter by 5 feet long cleaners to large roughers 8 feet in diameter and 40 feet long. In one example, the linear length is about 96 inches. In another embodiment, the sizes are much larger.

The spirals that line the inside of the trough are situated such that heavy material is carried towards the front of the unit during rotation. Feed can be introduced about halfway into the unit. Wash water can be delivered by a spray bar and associated spray heads of nozzles 140 from the point of feed entry to the front end of the first separator. This water (W) is sprayed towards the back end of the unit. As the first separator rotates clockwise, the water spray washes lighter material over the spirals and out the back end. The concentrate is directed by centrifugal force and gravity into the troughs or grooves 120 of the spirals and is carried to the front of the multi-spiral separator where it is collected.

The methods and systems can segregate the material and particles that are fine/light from those that are course/dense based on their size and specific gravity. The separation effect can be separating by hindered-settling principles. With hindered settling, that is in a restricted area, dense particles fall at a greater rate than light particles of the same settling rate under free settling conditions. The density of a suspension of solid particles in a fluid is the mean density of the suspension.

Another embodiment includes a method in accordance with the present invention is also disclosed. Broadly speaking, the present invention discloses a method for separating material from a feed mixture also comprising material having a multiple specific gravity, the method comprising: combining the mixture with a fluid (e.g., water) thereby forming a slurry; feeding the slurry onto the upper, separating surface of a downwardly sloped passage at the raised feed end thereof, the passage comprising metal and being sufficiently long to achieve at least partial gravity separation of the slurry flows downwardly over the separating surface or trough; applying a second spiral concentrator causes the material flows upward along the separating surface. This reduces the build-up along the trough or runway.

One embodiment of the invention can reduce water consumption of a separation process based on yield. The method and system may use a liquid such as water (water with media), for example, to separate particles according to the particles' settling velocities and densities. The water may be injected at various places, e.g., as shown in the figures.

The multi-spiral separator 100 can be positioned on an adjustable incline angle A of between 0 and 30 degrees with respect to the horizontal plane or between about 10 and 25 degrees with respect to the horizontal plane or between 3 and 15 degrees with respect to the horizontal plane. In one embodiment the multi-spiral separator can be inclined at a slight angle to the horizontal, with the potential use of a continuous multi-spiral separator to facilitate constant embodiments the angle of inclination can be about 1, 2, 3, 4, 5, 6, 7, 8, 9, 10, and 12 degrees. In various embodiments the angle of inclination can be between any two of the above specified angles. In various embodiments the angle of inclination can be varied between any two of the above specified angles. The optimal angle of incline may depend on general size and shapes of the materials being separated.

A slurry of material can be introduced to the multi-spiral separator 100. Sand, dirt or other materials may be added to the material to improve separation or density separation. The waste stream or material may be introduced into the system. From the feeder, the waste stream or material flows into a multi-spiral separator 100. The multi-spiral separator can be at an angle A with respect to the ground or the horizontal plane. The multi-spiral separator uses settling velocities of particles in a liquid (such as water) to separate particles having different characteristics. For example, denser materials fall at a faster rate than less dense materials. Spherical materials may fall faster through the liquid than less-spherical materials of similar density (that is materials flatter in shape). The heavies or heavy materials contain metals and the light materials contain less valuable material. The lights may be sent to a “scavenger stage” meaning a separation operation which is performed directly or indirectly on a primary tailings component from a rougher stage, directly or indirectly on a tailings component from a cleaner stage, directly or indirectly on a tailings component from a recleaner stage, or a combination thereof.

The overall method can be substantially continuous. Certain steps, however, can be batch or semi-batch processes. For example, the separation step can be a multi-stage, semi-batch process. The metal-containing material can be exposed to the separation step in a countercurrent process to form the metal and a residue. After being depleted of the metal, the metal-containing material becomes a residue. During the separation step, batches of the metal-containing material can be moved between two or more stations in series, such as in baskets. The material can be moved through these stations in a direction opposite to the direction in which the batches of metal-containing material are moved. In this way, the metal-containing material is in contact with multi-spiral separator having a lower concentration of the metal as the metal-containing material moves through the process, and the concentration of metal in the metal-containing material decreases.

A size reducer can also be employed. The size reducer can be a ball mill, crusher, shredder, or like apparatus capable of reducing the size of the materials sent to the size reducer. Upon the materials being reduced in size, the materials may be sent back to a screen for further separation. Both crushing and grinding lead to size reduction of the material or to “comminution.” Ball milling can be used to prepare powdered materials, e.g., materials greater than 35 or 50 mesh (e.g., about 100 mesh or 80 mesh).

The materials can be segregated into discrete size ranges based on, e.g., commercially available equipment and specifications. Exemplary and illustrative size ranges include about 2 to about 6 mm, about 6 to about 10 mm, about 10 mm to about 17 mm. about 17 mm to about 25 mm. about 25 mm to about 35 mm, and about 35 mm to about 100 mm. Materials about 100 mm and greater are removed from the system 100 through manual or automatic processing. An exemplary optimal size ratio upon segregation is about 3:1. Separation of the materials into discrete batch size ranges provides more effective processing at later processing stages of the system. More particularly, each fraction can be batched through system to promote efficiency. In one embodiment, the ratio of the upper cut to lower cut may be less than 4.

Optionally, certain embodiments can include a thickener, which is usually carried out in decantation tanks employing gravity sedimentation. These tanks may be fitted with mechanical scrapers to collect and move the settled solids to the point of discharge, the clear overflow being collected and removed by means of peripheral launders.

The various embodiments are based on and can include modes. In batch mode, a rapidly rotating cylindrical screen with material placed inside is vibrated so that the materials or fines pass along the outer screen wall where they are collected. In continuous mode, a rapidly rotating conical screen has material introduced inside of the small end and is vibrated so that material flows along its inner wall. The materials or fines pass along the screen wall where it is collected, and the coarse material travels axially out the end.

As used herein, the terms “heavier” and “lighter” refer to relatively greater and lesser specific gravity, respectively. Within the fluidic separator, absolute weight is less important than buoyancy in the fluid. For example, a four-ounce piece is lighter than a three-ounce piece if the three-ounce piece has a greater specific gravity than the four-ounce piece.

In one embodiment, the system and method can be used to separate or classify metals or materials with a minor difference in specific gravity. In one example, the system and method can separate iron and copper with a high efficiency. In other example, the system and method can separate zinc and copper. The system and method can separate heavier (e.g., precious metals, lead, and iron) and light metals (e.g., aluminum or magnesium) in operation.

The overall method can be substantially continuous. Certain steps, however, can be batch or semi-batch processes. For example, the separation step can be a multi-stage, semi-batch process. The metal-containing material can be exposed to the separation step in a countercurrent process to form the metal and a residue. After being depleted of the metal, the metal-containing material becomes a residue. During the separation step, batches of the metal-containing material can be moved between two or more stations in series, such as in baskets. The material can be moved through these stations in a direction opposite to the direction in which the batches of metal-containing material are moved. In this way, the metal-containing material is in contact with multi-spiral separator having a lower concentration of the metal as the metal-containing material moves through the process, and the concentration of metal in the metal-containing material decreases.

The methods and systems can be automated to allow higher efficiencies. The systems and methods may employ proportional-integral-derivative controllers, which can allow, e.g., control and monitoring of the speeds of the components, the angles of the spiral separators (e.g., with respect to the ground), flow of the slurry or waste stream (or specific gravity of slurry), the flow of water or wash fluid, or a combination thereof. The spiral separators that can be adjusted with such flexibility can result in higher efficiencies. By employing automatic controllers and monitors, the process can allow reduced downtime and greater flexibility.

Although specific embodiments of the present invention have been described in this application in detail, the description is merely for purposes of illustration. It should be appreciated, therefore, that many aspects of the invention were described above by way of example only and are not intended as required or essential elements of the invention unless explicitly stated otherwise. Certain steps and components in the exemplary processing methods and systems described herein may be omitted, performed and a different order, and/or combined with other steps or components. Various modifications of, and equivalent components corresponding to, the disclosed aspects of the exemplary embodiments, in addition to those described herein, can be made by those having ordinary skill in the art without departing from the scope and spirit of the present invention described herein and defined in the following claims, the scope of which is to be accorded the broadest interpretation so as to encompass such modifications and equivalent structures.

1. A method of sorting and separating waste material, comprising the steps of:
a. providing the waste material containing waste particles;
b. providing a multi-spiral separator having two separators in an elongated trough, a first separator with grooves and first blades having an upper end and a lower end, and a second clearing separator with second blades capable of clearing the trough;
c. introducing the waste material into the multi-spiral separator;
d. separating the waste material using the multi-spiral separator, wherein the waste particles separate according to the particles' settling velocities or densities, wherein a heavy fraction settles into the grooves and a light fraction remains at the top of the waste stream; and the heavy fraction moves up the multi-spiral separator to be collected, while the light fraction exits at the lower end of the trough.

2. A method of claim 1, further comprising introducing water along with the waste material into the multi-spiral separator.

3. A method of claim 1, wherein the first separator directs the heavy waste material to the upper end.

4. A method of claim 1, wherein the second separator pushes the waste material to the lower end.

5. A method of claim 1, wherein the angle of the multi-spiral separator is between 0 and 25 degrees with respect to the horizontal plane.

6. A method of claim 1, wherein the multi-spiral separator comprises nozzles configured to spray liquid onto the waste stream along the length of the trough, creating a liquid stream that pushes the light fraction opposite the direction of the heavy fraction.

7. A multi-spiral separator for separating waste material, comprising:
a. a first separator with a upper end and a lower end;
b. a second clearing separator;
c. a trough, wherein the first and second separators reside, with the first separator smaller than the second separator.

8. A multi-spiral separator of claim 7, wherein the second cleaner separator is a spiral screw.

9. A multi-spiral separator of claim 7, wherein the spiral screw extends from the upper end to less than the lower end.

10. A multi-spiral separator of claim 7, wherein the spiral screw has blades.

11. A multi-spiral separator of claim 7, wherein the first separator uses a left-handed screw.

12. A multi-spiral separator of claim 7, wherein the second separator is on the side opposite to the blade direction of the first separator.

13. A multi-spiral separator of claim 7, wherein the first separator uses a right-handed screw.

14. A multi-spiral separator of claim 7, wherein the first separator uses a left-handed screw.

15. A multi-spiral separator of claim 7, wherein the first separator uses a left-handed screw.

16. A multi-spiral separator of claim 7, further comprising a weir at the lower end.

17. A multi-spiral separator of claim 7, wherein lighter material of the waste overflows the weir.

18. A multi-spiral separator of claim 7, wherein the second separator is a ribbon screw.

19. A system for separating waste material, comprising:
a. a source of material that is incinerator ash, automobile shredder residue, whitegood shredder residue, e-waste, building components, waste-to-energy slag, steelmaking slag, ferrochrome slag, retrieved landfill material, or a combination thereof;
b. a multi-spiral separator configured to separate the material into a heavy fraction and the light fraction, wherein a multi-spiral separator comprises two separators in an elongated trough, a first separator with grooves and first blades having upper end and a lower end and a second clearing separator having second blades capable for clearing the elongated trough;
c. a collector.

20. The system of claim 19, wherein the nozzles deliver a stream of wash liquid the multi-spiral separator to push the light fraction in a direction opposite the heavy fraction.
